(19) United States
(12) Patent Application Publication
(10) Pub. No.: US 2021/0116557 A1
(43) Pub. Date: Apr. 22, 2021

(54) Radio-Based Object Detection

(71) Applicant: Sony Corporation, Tokyo (JP)

(72) Inventors: Rickard LJUNG, Helsingborg (SE); Erik BENGTSSON, Eslöv (SE); Magnus PERSSON, Flyinge (SE); Zhinong YING, Lund (SE)

(21) Appl. No.: 16/494,305

(22) PCT Filed: Mar. 17, 2017
(86) PCT No.: PCT/EP2017/056408

§ 371 Date: Sep. 15, 2019

(51) Int. Cl. G01S 13/87; G01S 13/42; G01S 7/00

(52) U.S. Cl. CPC G01S 13/872; G01S 7/003; G01S 13/42

(57) ABSTRACT

The present invention relates to a radio-based object detection method. According to the method, first location information relating to an object of interest (31) are determined with a first device (11) using radio waves. Based on the first location information, a second device (21) from a plurality of candidate devices (21 to 29) is selected. A request for determining second location information relating to the object of interest (31) is transmitted via a telecommunication network to the second device (21).

### FIELD OF THE INVENTION

The present invention relates to methods for detecting or locating objects in an environment using radio waves. The present invention relates furthermore to devices implementing the methods.

### BACKGROUND OF THE INVENTION

Object detection, for example localizing and determining a movement of an object, may be advantageous or required in several applications, for example in vehicle control and monitoring systems of air-, land- or water-based vehicles, and monitoring of buildings and sites.

For example, radar technology enables an accurate object detection. Radar is an object detection system that uses radio waves to determine the range, angle or velocity of objects. However, in particular when monitoring objects near or on the ground, radar systems may suffer from disturbed radio waves, for example absorbed, attenuated or reflected radio waves in urban environments, for example in street canyons.

### SUMMARY OF THE INVENTION

In view of the above, there is a need in the art for methods and devices, which address at least some of the above shortcomings of radar systems. In particular, there is a need in the art for improving the radar-based object detection in complex topologies, for example in city centres.

According to the present invention, this object is achieved by the features of the independent claims. The dependent claims define embodiments of the invention.

According to the present invention, a radio-based object detection method is provided. According to the method, first location information relating to an object of interest is determined with a first device using radio waves. For example, the first location information may be determined using a time of flight measurement of the radio waves. Additionally or as an alternative, an angle of departure and/or an angle of arrival of the radio waves may be considered for determining the first location information relating to the object of interest. Based on the first location information, a second device is selected from a plurality of candidate devices. For example, positions of each of the plurality of candidate devices may be provided and a device, which is arranged close to the object of interest may be selected as the second device. For example, the second device may be selected based on a distance between the determined location of the object of interest and the location of the second device. Further, for example, the device, which is arranged closest to the object of interest may be selected as the second device. A request for determining second location information relating to the object of interest is transmitted to the second device via a telecommunication network.

According to the present invention, a further radio-based object detection method is provided, according to which at a second device a request for determining second location information relating to an object of interest is received via a telecommunication network. Upon receiving the request, the second location information relating to the object of interest is determined with the second device using radio waves. For example, the second location information may be determined using a time of flight measurement of radio waves. Additionally or as an alternative, an angle of departure and/or an angle of arrival of the radio waves may be considered by the second device for determining the second location information relating to the object of interest. The second device may cooperate with the first device, for example the method performed in the second device may be started when the second device receives the request for determining the second location information from the first device.

The first device may comprise a radar base station or a base station of the telecommunication network with an integrated radar system. The first device may monitor the object of interest, for example a location, a moving direction or a speed of the object of interest, based on the first location information. However, in case the radio waves used for determining the first location information are disturbed, for example by obstacles arranged between the first device and the object of interest, or more precise monitoring is required, the second device may be requested to determine the second location information relating to the object of interest. The second device may comprise for example a user equipment, for example a mobile phone including radar capabilities, for example short range radar capabilities. The second device may be selected such that the object of interest is arranged near to the second device and thus the second device is capable of determining second location information relating to the object of interest.

According to an embodiment, the request for determining the second location information this indicative of the first location information. By providing the first location information in the request for determining the second location information, the second device gets a rough information where to search for the object of interest or which area is to be scanned.

According to another embodiment, the request for determining the second location information is indicative of a scanning region associated with the first location information. For example, the second device may scan the region provided in the request for determining the second location information. In the scanned region, the second device may localize the object of interest and determine its location. As only a given region is to be analyzed, the effort for determining the second location information may be reduced. This may save processing power and electrical energy in the second device.

According to a further embodiment, the request for determining the second location information comprises a scheduling grant for time-frequency resources allocated to the second device for using the radio waves. For example, the request for determining the second location information may be transmitted from the first device to the second device via the wireless telecommunication network in which a plurality of time-frequency resources for communicating control and payload data are defined. The time-frequency resources allocated to the radio waves used for determining the second location information may comprise licensed radio resources of the wireless telecommunication network. This may enable the second device to perform the location determination of the object of interest with radio waves transmitted via the same transceiver and same antenna elements, which are used for communicating with the wireless telecommunication network. Furthermore, no additional radio resources are to be provided to the second device to perform the determination of the second location information relating to the object of interest.

According to an embodiment, the second location information is received via the telecommunication network from the second device, and a location of the object of interest is determined based on the first location information and the second location information. For example, the first device may monitor the object of interest based on its own determination of the first location information in a large scale monitoring. If necessary, the first device may request and receive the second location information from the second device for certain areas, for example in complex topologies like street canyons between high buildings where its own location determination may lose track of the object of interest or may be rather inaccurate.

According to an embodiment, further location information relating to the second device is determined and a relative arrangement of the object of interest with respect to the second device is determined. The second location information is determined based on the further location information relating to the second device and the relative arrangement of the object of interest with respect to the second device. The further location information relating to the second device may comprise for example a position of the second device in a global reference frame, for example latitude and longitude, and additionally an orientation of the second device, for example azimuth and inclination. The relative arrangement of the object of interest with respect to the second device may comprise an angle and distance of the object of interest relative to a reference frame of the second device. Furthermore, the relative arrangement of the object of interest with respect to the second device may comprise an image of an area including the object of interest, for example a depth map determined by the second device based on the radio waves.

Based on the request, at least one transmit angle of the radio waves may be determined. For example, based on the first location information or the scanning region provided in the request, a transmit angle of the radio waves may be determined by the second device. The radio waves may be sent along the at least one transmit angle using a phased array of antenna elements of the second device. This may enable to scan the object of interest efficiently with respect to time and energy.

According to an embodiment, the reflected radio waves are received with a phased array of antenna elements of the second device. Based on the receive properties of the plurality of radio waves, a direction information indicating a direction of the object of interest with respect to the second device is determined. For example, an angle of arrival may be determined based on the receive properties of the plurality of radio waves. The second location information may be determined based on the direction information.

The second location information may comprise for example information indicative of a receive property of the reflected radio waves. The receive property of the reflected radio waves may comprise low level radar detection information, for example raw data of signals from a transceiver coupled to the antenna of the second device. Analysing this raw data information may be performed in the first device to determine the location of the object of interest. Additionally or as an alternative, the second location information may comprise location coordinates of the object of interest determined based on the reflected radio waves. The location coordinates may represent a location in a global reference system of frame, for example longitude and latitude. Furthermore, additionally or as an alternative, the second location information may comprise an image of an environment including the object of interest determined based on the reflected radio waves. For example, the second device may scan its environment or at least a part of the environment in which the object of interest is located with radio waves. For example, the second device may scan its environment with a pencil beam emitted from a phased array of antenna elements of the second device and may determine a three-dimensional depth map based on reflections of the pencil beam. The three-dimensional depth map may be transmitted as the second location information to the first device for determining the location of the object of interest.

Additionally, further location information relating to the second device may be communicated from the second device to the first device via the telecommunication network. The further location information may include a position information of the second device in terms of longitude and latitude information as well as an orientation of the second device in terms of azimuth and inclination.

According to another embodiment, the telecommunication network comprises a wireless telecommunication network and the first and second devices comprise network nodes of the wireless telecommunication network. For example, the first device may comprise a base station of the wireless telecommunication network and the second device may comprise a terminal device, for example a user equipment like a mobile telephone, which is operated in the wireless telecommunication network.

According to the present invention, a device is provided which comprises an antenna, a transceiver coupled to the antenna and configured to communicate via a telecommunication network, and a controller. The device may comprise for example a base station of a wireless telecommunication network. The controller is configured to determine first location information relating to an object of interest using radio waves transmitted via the transceiver and antenna. The first device may utilize radar technologies to determine the first location information. For example, the first device may determine the first location information using radio waves in a frequency band or frequency range which is licensed to be used by the first device for communicating information via the telecommunication network. The controller is furthermore configured to select a further device from a plurality of the candidate devices based on the first location information. The plurality of candidate devices may comprise terminal devices or user equipment devices like mobile telephones, arranged for communicating information via the telecommunication network. The telecommunication network may comprise a wireless telecommunication network, for example cellular wireless telecommunication network. For example, the controller may determine the position of each of the plurality of candidate devices and may select a device which is arranged close to the object of interest as the further device. Finally, the controller is configured to transmit a request for determining second location information relating to the object of interest to the further device via the telecommunication network.

The device may furthermore be configured to perform the above-described method or any one of the above-described embodiments of the method as the first device.

Furthermore, according to the present invention, a device is provided which comprises an antenna, a transceiver and a controller. The transceiver is coupled to the antenna and configured to communicate information via a telecommunication network. The device may comprise for example a terminal device or user equipment like a mobile telephone, which may be operated for communicating information via the telecommunication network. The controller is configured to receive a request for determining location information relating to an object of interest. The request is received from a further device via the telecommunication network. The further device may comprise for example a base station of the telecommunication network. Upon receiving the request, the controller is configured to determine location information relating to the object of interest using radio waves transmitted via the transceiver and the antenna.

The device may furthermore be configured to perform the above-described method or any one of the above-described embodiments of the method as the second device.

Thus, the first and second device may cooperate to enhance localisation of the object of interest.

Although specific features described in the above summary and the following detailed description are described in connection with specific embodiments and aspects of the present invention, it should be understood that the features of the exemplary embodiments and aspects may be combined with each other unless specifically noted otherwise.

### BRIEF DESCRIPTION OF THE DRAWINGS

In the following, the present invention will be described in more detail with reference to the accompanying drawings.

FIG. 1 shows schematically devices according to embodiments of the present invention.

FIG. 2 shows schematically method steps of a method according to an embodiment of the present invention.

FIG. 3 shows schematically devices according to embodiments of the present invention in more detail.

### DETAILED DESCRIPTION OF EMBODIMENTS

In the following, exemplary embodiments of the present invention will be described in more detail. It is to be understood that the features of the various exemplary embodiments described herein may be combined with each other unless specifically noted otherwise. Same reference signs in the various drawings refer to similar or identical components. Any coupling between components or devices shown in the figures may be a direct or indirect coupling unless specifically noted otherwise.

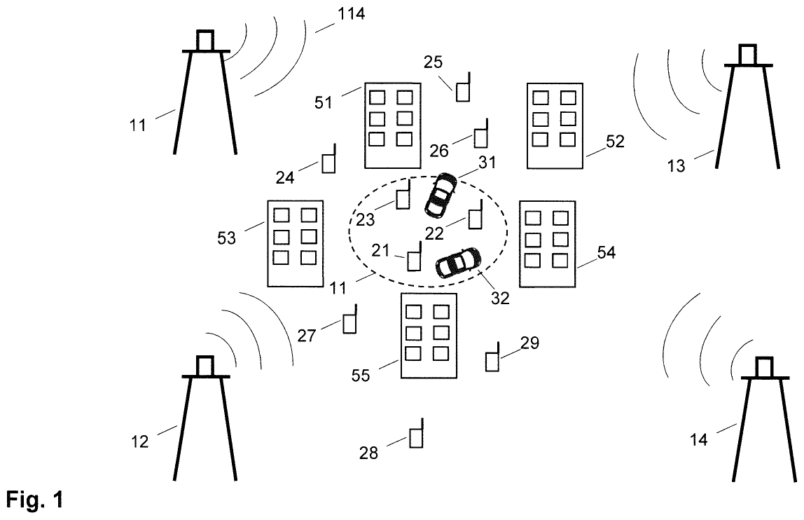

FIG. 1 shows schematically an arrangement of a plurality of first devices 11 to 14 and second devices 21 to 29.

The first devices 11 to 14 may comprise base stations of a wireless telecommunication network, for example a cellular wireless communication network. Additionally or as an alternative, the first devices 11 to 14 may comprise radar base stations equipped with modems for wireless communication, which may enable the radar base stations to communicate over cellular protocols.

The second devices 21 to 29 may comprise terminal devices, for example mobile user equipment devices, e.g. mobile telephones, smart phones, tablet PCs and the like.

The first devices 11 to 14 may be configured to form a radar system for monitoring objects of interest by transmitting radar signals and receiving reflected radar signals from the monitor art objects. For example, the first device 11 may transmit radio waves as radar signals 114 for monitoring objects of interest 31 and 32. The objects of interest may comprise for example vehicles, for example, air-, land- or water-based vehicles. However, depending on the deployment strategy of the first devices 11 to 14 and the topology of the monitored area, the radar signals may not be able to fully characterise the environment, especially relatively close to the ground level. For example in an urban area comprising buildings 51 to 55 as shown in FIG. 1, certain areas may be difficult to be monitored by the first devices 11 to 14. For example, in case of an object of interest being located within a central area 40 within the centre of the illustrated buildings 51 to 55, this area 40 could be difficult for the first devices 11 to 14 of the radar system to be characterised in detail due to many obstacles affecting the radar signals 114 from the first devices 11 to 14.

As described above, the first devices 11 to 14 are capable of utilising mobile communication to contact network nodes, for example the second devices 21 to 29, which may be in close proximity to the objects of interest 31 and 32. Therefore, the second devices 21 to 29 may be utilised to support the radar system comprising the first devices 11 to 14 to determine the location of the object of interest 31 and 32.

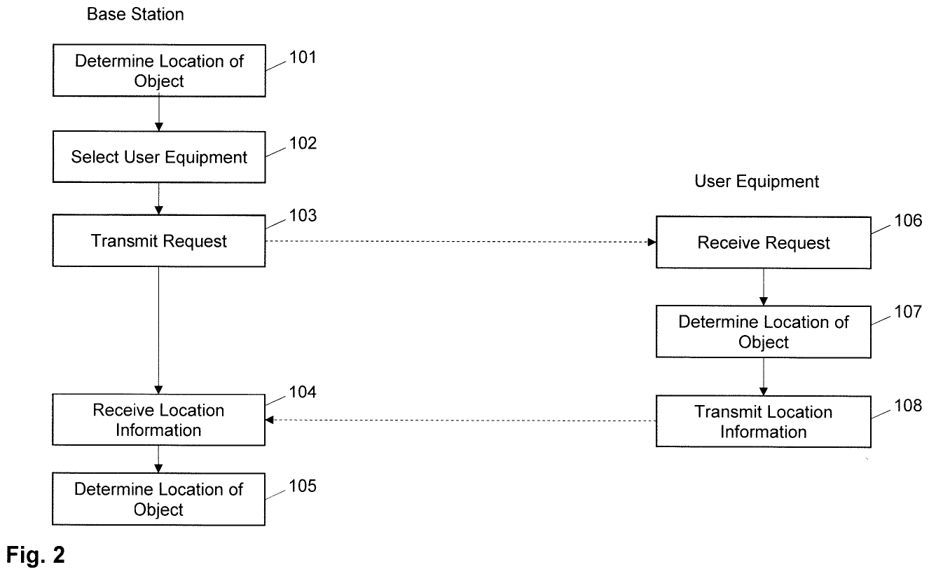

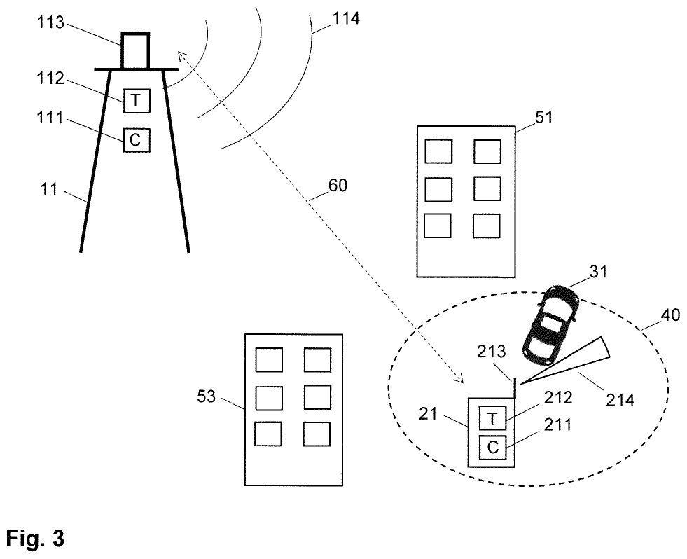

A corresponding method will be described in the following in connection with method steps 101 to 108 shown in FIG. 2 and an enlarged partial view of the arrangement of FIG. 1 shown in FIG. 3.

FIG. 3 shows the first device 11 in more detail. The first device 11 comprises a controller 111, a transceiver 112 and an antenna 113. The antenna 113 may comprise an antenna array of a plurality of antenna elements adapted to transmit and receive radar signals as well as communication signals for communicating data according to for example wireless cellular telecommunication technologies. However, as an alternative, the first device 11 may comprise the radar functionality only and may be coupled to a base station of a wireless telecommunication network for communicating data according to the wireless cellular telecommunication technologies.

Furthermore, FIG. 3 shows the second device 21 in more detail. The second device 21 comprises a controller 211, a transceiver 212 and an antenna 213. The transceiver 212 is coupled to the antenna 213 and configured to communicate information via a telecommunication network, for example according to a cellular wireless telecommunication network technology.

Operation of the first device 11 and the second device 21 will be described in the following in connection with FIG. 2. Method steps 101 to 105 are performed by the first device 11, for example a base station of a radar and telecommunication system. Method steps 106 to 108 are performed by the second device 21, for example a user equipment like a mobile telephone, a smart phone or a tablet PC.

In step 101, the first device 11 determines a first location information relating to the object of interest 31, for example a vehicle. The first device 11 determines the first location information by using radio waves. For example, the first device 11 may utilise a time of flight measurement of radio waves 114 transmitted from the antenna 113, reflected from the object of interest 31, and received at the antenna 113. Additionally or as an alternative, the first device 11 may transmit a directed radio beam with an antenna arrangement of the antenna 113 to scan an environment of the first device 11. Based on the angle of departure of the directed radio beam and the time of flight of the directed radio beam including its reflection from objects in the environment, for example from the buildings 51 and 53 and the object of interest 31, a three-dimensional depth map of an environment of the first device 11 may be generated. Additionally or as an alternative, an angle of arrival of the reflected radio beam may be utilized to generate the three-dimensional depth map. In other words, the first device 11 characterises an area of its environment by means of sending radar signals or pulses and analysing the reflections from these signals and pulses. A radar system may consist of one or many transmitters and receivers. The receivers may be co-located with the transmitters or maybe spaced apart from the transmitters.

When the radar system is monitoring a certain object of interest, for example the object of interest 31, the detection capabilities for a certain area, for example the area 40 indicated in FIG. 3, may not be sufficient, for example due to obstacles like the buildings 51 and 53. Therefore, the first location information may not have a sufficient accuracy and an improvement is required.

In this case, the first device 11 may select in step 102 one of the second devices 21 to 29 based on the first location information, which represents a coarse position of the object of interest 31 only. For example, the first device 11 may select the second device 21 due to its proximity to the position of the object of interest 31. In step 103 the first device 11 transmits a request to the selected second device 21 for determining second location information relating to the object of interest 31. The request is transmitted via a wireless communication 60 of the wireless telecommunication network. The first and second devices 11, 21 may both operate according to wireless communication techniques defined for the telecommunication network.

Upon receiving the request for determining the second location information relating to the object of interest 31 at the second device 21 in step 106, the second device 21 determines location information relating to the object of interest 31 in step 107. The second device 21 determines the location information relating to the object of interest 31 by using radio waves 214. The second device 21 may utilise radio technologies like time of flight, angle of arrival and angle of departure measurements using radio waves 214. With the request, the second device 21 may be requested to investigate its close proximity with radar detection techniques. For example, the request may include a specific scanning area, defining a geographical area to be categorized or investigated via the radar detection techniques. Such scanning area may be defined for example by geographical coordinates.

The radar detection by the second device 21 may be conducted by means of sweeping a set of radar transmissions 214 with determined angular difference between each radar transmission. The request received from the first device 11 may specify such radar direction sweeping characteristics. For example, such characteristics may be the angular difference between the radar transmissions, a minimum of different radar transmissions, a maximum allowed angle between each radar transmission or the like. The request from the first device 11 may also include a determination of the antenna configuration of the antenna 213 of the second device 21, defining for example a beam width of a beamforming which shall be used by the second device 21 for each radar signal transmission.

Furthermore, the request from the first device 11 may also include a specific resource scheduling to be used for the radar signal by the second device 21. The resource scheduling may comprise a time and frequency to be used for transmitting the radar signal. The resource may comprise a resource of a so-called “licensed band” of the wireless telecommunication network in which the second device 21 is operated. In other words, the resource allocation may overlap with the resources (time and frequency) that are used for the wireless communication system, which means that the radio access system could use a portion of its resources for the radar signal transmission.

When the radio resource is included in the request in step 103, the first device 11 and therefore the whole radar system comprising the first devices 11 to 14 may have knowledge about the time and frequency (resource) of the radar signals from the second device 21. Additionally, the location of the second device 21 may be communicated to some or all first devices 11 to 14 of the radar system. Based on this information, one or more of the first devices 11 to 14 may also listen to radar signals emitted from the second device 21 and may perform a passive radar detection method to determine characteristics of the area of interest 40 and/or the location of the object of interest 31.

Furthermore, the request from the first device 11 for determining second location information relating to the object of interest 31 may include an indicator of which kind a response including the second location information is requested from the second device 21. For example, the response from the second device 21 may the requested to include a high level result such as an image or picture like a three-dimensional depth map of the environment, or low level radar detection information which may be analysed by the first device 11.

Additionally, the second device 21 may include into the second location information further location information relating to its own geographic position, for example in terms of latitude, longitude, azimuth and/or inclination as well as details of geographic information of measurements for each of the radar transmissions.

In step 108 the second device 21 transmits the second location information to the first device 11. The second location information may comprise a format as requested.

In step 104, the first device 11 receives the second location information provided by the second device 21 and may enhance its characteristic and analysis of the area of interest 40 and the object of interest 31 within that area 40 based on the second location information.

It is to be noted that in case the communication within the wireless communication network and the radar signals transmitted by the first and/or second devices 11 to 14 and 21 to 29 are both using radio waves within similar frequency ranges, hardware components, for example antennas 113 and 213 and transceivers 112 and 212 may be reused within the first and second devices for these two types of transmissions.

1. A radio-based object detection method, comprising
determining, with a first device, first location information relating to an object of interest using radio waves;
selecting a second device from a plurality of candidate devices based on the first location information;
transmitting, via a telecommunication network, to the second device a request for determining second location information relating to the object of interest
receiving at the second device, via the telecommunication network, the request for determining second location information relating to the object of interest;
determining, with the second device, the second location information relating to the object of interest using radio waves;
determining further location information relating to the second device; and
determining a relative arrangement of the object of interest with respect to the second device; and
wherein the determining the second location information is based on the further location information of the second device and the relative arrangement of the object of interest with respect to the second device.

2. (canceled)

3. The method of claim 1, wherein the request for determining second location information is indicative of the first location information.

4. The method of claim 1, wherein the request for determining the second location information is indicative of a scanning region associated with the first location information.

5. The method of claim 1, wherein the request for determining the second location information comprises a scheduling grant for time-frequency resources allocated to the second device for using the radio waves.

6. The method of claim 1, further comprising:
receiving, via the telecommunication network, from the second device the second location information; and
determining a location of the object of interest based on the first location information and the second location information.

7. (canceled)

8. The method of claim 1, further comprising:
determining at least one transmit angle of the radio waves based on the request,
sending the radio waves along the at least one transmit angle using a phased array of antenna elements of the second device.

9. The method of claim 1, further comprising:
receiving reflected radio waves with a phased array of antenna elements of the second device; and
determining, based on receive properties of the plurality of radio waves, a direction information indicating a direction of the object of interest with respect to the second device,
determining the second location information based on the direction information.

10. The method of claim 1, wherein the second location information comprises at least one of:
information indicative of a receive property of reflected radio waves,
location coordinates of the object of interest determined based on reflected radio waves, and
an image of an environment including the object of interest determined based on reflected radio waves.

11. The method of claim 1, further comprising:
communicating, from the second device to the first device and via the telecommunication network, further location information relating to the second device.

12. The method of claim 1, wherein the telecommunication network comprises a wireless telecommunication network, wherein the first and second devices comprise network nodes of the wireless telecommunication network.

13. A system comprising:
a first device, comprising:
a first device antenna,
a first device transceiver coupled to the first device antenna and configured to communicate information via a telecommunication network, and
a first device controller configured to
determine first location information relating to an object of interest using radio waves transmitted via the first device transceiver and first device antenna,
select a second device from a plurality of candidate devices based on the first location information, and
transmit to the second device, via the telecommunication network, a request for determining second location information relating to the object of interest
the second device comprising:
a second device antenna,
a second device transceiver coupled to the second device antenna and configured to communicate information via the telecommunication network, and
a second device controller configured to
receive from the first device, via the telecommunication network, a request for determining location information relating to the object of interest, and
upon receiving the request, determine location information relating to the object of interest using radio waves transmitted via the second device transceiver and second device antenna; and
wherein the system:
determines further location information relating to the second device;
determines a relative arrangement of the object of interest with respect to the second device; and
determines the second location information is based on the further location information of the second device and the relative arrangement of the object of interest with respect to the second device.

14-16. (canceled)
